(19) United States
(12) Patent Application Publication
(10) Pub. No.: US 2026/0030362 A1
(43) Pub. Date: Jan. 29, 2026

(54) API attack script generation

(71) Applicant: Palo Alto Networks, Inc., Santa Clara, CA (US)

(72) Inventors: Aviv Sasson, Petah Tikva (IL); Ravid Mazon, Kfar Saba (IL); Jay Chen, Fairfax, VA (US)

(21) Appl. No.: 18/786,637

(22) Filed: Jul. 29, 2024

(51) Int. Cl. G06F 21/57

(52) U.S. Cl. CPC G06F 21/577; G06F 2221/033

(57) ABSTRACT

Methods, storage systems and computer program products implement embodiments of the present invention for testing a software application by inputting, to an LLM, a specification of an API of the software application, and prompting the LLM to identify, based on the specification, a set of API consumers that access information provided by the software application. For each given API consumer in the set, the LLM is prompted to identify, based on the specification, one or more execution paths leading to the given consumer from respective API producers, which deliver the information to the software application, and the LLM is prompted to generate, based on the specification, respective test scripts to test the identified execution paths. Finally, the software application is tested with the generated test scripts to discover a security vulnerability in the software application. Additional embodiments can be used to generate artificial user identities for testing the software application.

### FIELD OF THE INVENTION

The present invention relates generally to computer security, and particularly to generating test scripts that can be used to detect a vulnerability in a software application to a broken object level authorization (BOLA) attack.

### BACKGROUND OF THE INVENTION

Broken object level authorization (BOLA) is a security vulnerability that occurs when an application or application programming interface (API) provides access to data objects based on a role of a user, but fails to verify if the user is authorized access those specific data objects. This vulnerability allows malicious users to bypass authorization and access user information (that may comprise sensitive data) or execute unauthorized actions like manipulating (editing/deleting) other users resources, to which they would otherwise not have access.

In a BOLA attack example, an e-commerce web-based application allows users to update their account information, such as email addresses using a user identifier (ID) as the sole basis for authorization. If a flaw exists in the application's business logic regarding the email update process, the application can fail to verify whether the user attempting to change the email address actually owns the account.

An attacker can identify and exploit this vulnerability by manipulating the requests sent to the server during the email update. For example, the attacker can change the user ID in the request, thereby tricking the application into updating the email address for an account that doesn't belong to them.

As a result, the attacker can successfully change the email address associated with another user's account without proper authorization. This unauthorized action could lead to various malicious activities, such as account takeover, unauthorized access to user information and manipulation (editing/deleting) of other users' resources.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method for testing a software application, including inputting, to a large language model (LLM), a specification of an application programming interface (API) of the software application, prompting the LLM to create, based on the specification, a set of artificial user identities, and testing the software application with the created user identities to discover a security vulnerability in the software application.

In one user identity embodiment, the API comprises multiple API endpoints, and wherein the specification of the API includes a specification of the API endpoints.

In another user identity embodiment, the security vulnerability includes a broken object level authorization vulnerability.

In an additional user identity embodiment, the specification includes an OpenAPI specification.

In a further user identity embodiment, the method further includes promoting the LLM to identify, based on the specification, a first set of information required to register each given artificial user identity with the software application, and generating, using the first sets of information, a registration test script to register the artificial user identities with the software application, and wherein testing the software application includes executing the registration test script.

In some user r identity embodiments, the method further includes promoting the LLM to identify, based on the specification, a second set of information required to log each given artificial user identity into the software application, and generating, using the second sets of information, a login test script to log the artificial user identities into the software application, wherein the second set includes a subset of the first set, and wherein testing the software application includes executing the registration test script.

In a supplemental user identity embodiment, the subset includes a proper subset.

There is also provided, in accordance with an embodiment of the present invention, a computer software product for identifying a vulnerability in a software application, the computer software product including a non-transitory computer-readable medium, in which program instructions are stored, which instructions, when read by a computer, cause the computer to input, to a large language model (LLM), a specification of an application programming interface (API) of the software application, to prompt the LLM to create, based on the specification, a set of artificial user identities, and to test the software application with the created user identities to discover a security vulnerability in the software application.

There is additionally provided, in accordance with an embodiment of the present invention, a method for testing a software application, including inputting, to a large language model (LLM), a specification of an application programming interface (API) of the software application, prompting the LLM to identify, based on the specification, a set of API consumers that access information provided by the software application, for each given API consumer in the set, prompting the LLM to identify, based on the specification, one or more execution paths leading to the given consumer from respective API producers, which deliver the information to the software application, prompting the LLM to generate, based on the specification, respective test scripts to test the identified execution paths and testing the software application with the generated test scripts to discover a security vulnerability in the software application.

In one test script embodiment, the API includes multiple API endpoints, and the specification of the API includes a specification of the API endpoints.

In another test script embodiment, the API endpoints include producer and consumer API endpoints, wherein the producer API endpoints produce output, and wherein each of the consumer API endpoints consumes the output of a given producer API endpoint as an input parameter.

In an additional test script embodiment, each of the paths includes a given consumer API endpoints and one or more producer API endpoints.

In a further test script embodiment, the API specification includes information for each of the API endpoints, and further including generating for each given path, a trimmed API specification including the information for the producer API endpoint and the one or more producer API endpoints in the given path, and wherein prompting the LLM to generate the test script for the given path includes prompting the LLM to generate, based on the trimmed API specification, the test script for the given path.

In a supplemental test script embodiment, the method further includes identifying dependencies between the test scripts, ranking the test scripts based on their respective dependencies, and executing the test scripts in order of their respective rankings.

In a first test script ranking embodiment, ranking the test scripts includes identifying, for each of the consumer API endpoints, a primary key including a consumer operation selected from a list consisting of a GET operation, a POST operation, a PUT operation and a DELETE operation, and ranking the test scripts based on a primary key, wherein, in the primary keys, the ranking for a given script whose respective consumer operation includes a GET operation is greater than a given script whose respective consumer operation includes a POST operation, wherein the ranking for a given script whose respective consumer operation includes a POST operation is greater than a given script whose respective consumer operation includes a PUT operation, and wherein the ranking for a given script whose respective consumer operation includes a PUT operation is greater than a given script whose respective consumer operation includes a DELETE operation.

In a second test script ranking embodiment, the method includes including identifying a set of scripts having identical primary keys, identifying, for each of the producer API endpoints in the set, a secondary key including a producer operation selected from a list consisting of a POST operation, a GET operation, a PUT operation and a DELETE operation, and ranking the test scripts in the set based on the secondary key, wherein, in the secondary key, the ranking for a given script whose respective producer operation includes a POST operation is greater than a given script whose respective producer operation includes a GET operation, wherein the ranking for a given script whose respective producer operation includes a GET operation is greater than a given script whose respective producer operation includes a PUT operation, and wherein the ranking for a given script whose respective producer operation includes a PUT operation is greater than a given script whose respective producer operation includes a DELETE operation.

In a third test script ranking embodiment, wherein upon detecting one of the scripts including multiple producer endpoints, assigning a delete operation to the secondary key of detected script if any of the multiple producer endpoints in the detected script includes any DELETE operations, assigning a PUT operation to the secondary key of detected script if any of the multiple producer endpoints in the detected script includes any PUT operations and does not include any DELETE operations, assigning a POST operation to the secondary key of detected script if any of the multiple producer endpoints in the detected script includes any POST operations and does not include any DELETE operations or any PUT operations, and assigning a GET operation to the secondary key of detected script if any of the multiple producer endpoints in the detected script includes any GET operations and does not include any DELETE operations any PUT operations or any POST operations.

In one test script embodiment, the security vulnerability includes a broken object level authorization vulnerability.

In another test script embodiment, the specification includes an OpenAPI specification.

There is further provided, in accordance with an embodiment of the present invention, a computer software product for identifying a vulnerability in a software application, the computer software product including a non-transitory computer-readable medium, in which program instructions are stored, which instructions, when read by a computer, cause the computer to input, to a large language model (LLM), a specification of an application programming interface (API) of the software application, to prompt the LLM to identify, based on the specification, a set of API consumers that access information provided by the software application, for each given API consumer in the set, to prompt the LLM to identify, based on the specification, one or more execution paths leading to the given consumer from respective API producers, which deliver the information to the software application, to prompt the LLM to generate, based on the specification, respective test scripts to test the identified execution paths, and to test the software application with the generated test scripts to discover a security vulnerability in the software application.

### BRIEF DESCRIPTION OF THE DRAWINGS

The disclosure is herein described, by way of example only, with reference to the accompanying drawings, wherein:

FIG. 1 is a block diagram showing an example of a security workstation that is configured to detect a BOLA vulnerability in application programming interface (API) endpoints in a software application, in accordance with an embodiment of the present invention;

FIG. 2 is a block diagram showing data components of a dependency record used by the security workstation, in accordance with an embodiment of the present invention;

FIG. 3 is a block diagram showing data components of a dependency tree record used by the security workstation, in accordance with an embodiment of the present invention;

FIG. 4 is a block diagram showing data components of a path record used by the security workstation, in accordance with an embodiment of the present invention;

FIG. 5 is a flow diagram that schematically illustrates a method for detecting a BOLA vulnerability comprising a potentially vulnerable endpoint (PVE) in a software application, in accordance with an embodiment of the present invention;

FIG. 6 schematically shows an example of API endpoint dependencies in a software application, in accordance with an embodiment of the present invention;

FIG. 7 schematically shows an example of a dependency tree derived from endpoint dependencies, in accordance with an embodiment of the present invention;

FIG. 8 schematically shows an example of producer-consumer pairs in the dependency tree, in accordance with an embodiment of the present invention;

FIG. 9 schematically shows, an example of execution paths to a potentially vulnerable endpoint (PVE) in the dependency tree, in accordance with an embodiment of the present invention;

FIG. 10 is an example of a test script that the security workstation can execute so as to attempt to exploit a detected BOLA vulnerability, in accordance with an embodiment of the present invention; and

FIG. 11 is a flow diagram that schematically illustrates a method for using a large language model to generate artificial user identities and test scripts that attempt to exploit a detected BOLA vulnerability in the software application.

### DETAILED DESCRIPTION OF EMBODIMENTS

Embodiments of the present invention provide methods and systems for generating scripts that can be used to test software applications for security vulnerabilities such as Broken object level authorization (BOLA). In a BOLA cyberattack, an attacker attempts to exploit flaws in an application's authorization mechanisms in order to access or manipulate resources belonging to other users without proper permissions.

In a first embodiment, artificial user identities (IDs) can be created for the attacker and a given user whose resources are a target of the BOLA cyberattack. As described hereinbelow, a specification of an application programming interface (API) of the software application is input to a large language model (LLM), and the LLM is prompted to create, based on the specification, a set of artificial user identities (Ids). The software application can then be tested with the created user identities to discover a security vulnerability in the software application.

In a second embodiment, test scripts can be generated for use in testing the software application. As described hereinbelow, a specification of an application programming interface (API) of the software application is input to a large language model (LLM), and the LLM is prompted to identify, based on the specification, a set of API consumers that access information provided by the software application.

For each given API consumer in the set, the LLM is prompted to identify, based on the specification, one or more execution paths leading to the given consumer from respective API producers, which deliver the information to the software application. The LLM can then be prompted to generate, based on the specification, respective test scripts to test the identified execution paths.

Finally, the software application can with the generated test scripts to discover a security vulnerability in the software application. If the security vulnerability comprises a vulnerability to a BOLA cyberattack, the test scripts can include the artificial user identities generated in the first embodiment.

Some software applications can have in excess of 100,000 execution paths and a correspondingly large number of API endpoints. Using an LLM to analyze an API specification enables systems implementing embodiments of the present invention to generate artificial user identities and to generate test scripts (i.e., that can use the generated artificial user identities) to test a software application for security vulnerabilities such as BOLA regardless of the number of API endpoints and execution paths in the application.

In these embodiments, systems implementing embodiments of the present invention can perform a comprehensive BOLA detection analysis on a software application by identifying one or more potentially vulnerable endpoints (PVEs), identifying one of more execution paths to each of the identified PVEs, generating multiple test shell scripts that attempt to exploit each of the execution paths, and executing the shell scripts so as to detect any security vulnerabilities (e.g., BOLA vulnerabilities) in the software application.

### System Description

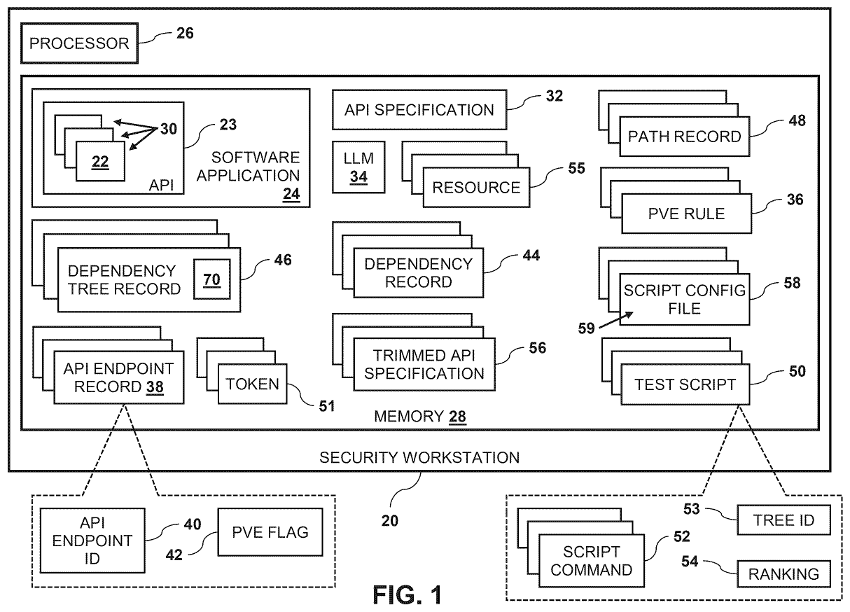

FIG. 1 is a block diagram showing an example of a security workstation 20 that is configured to detect a BOLA vulnerability in application programming interface (API) endpoints 22 that are accessible via an API 23 of a software application 24, in accordance with an embodiment of the present invention.

In the configuration shown in FIG. 1, security workstation 20 comprises a processor 26 and a memory 28. In addition to storing software application 24 comprising API endpoints 22 that have respective API endpoint IDs 30, memory 28 can also comprise (i.e., store) an API specification 32 that comprises a machine-readable interface definition language for describing and consuming (i.e., specifying required inputs to) the API endpoints in software application 24. In some embodiments API specification 32 may comprise an OpenAPI specification (also known as a SWAGGER specification) for software application 24.

Memory 28 may also comprise a large language model (LLM) 34 that processor 26 can use to analyze API specification 32, as described hereinbelow. In some embodiments, LLM 34 may comprise an LLM classifier.

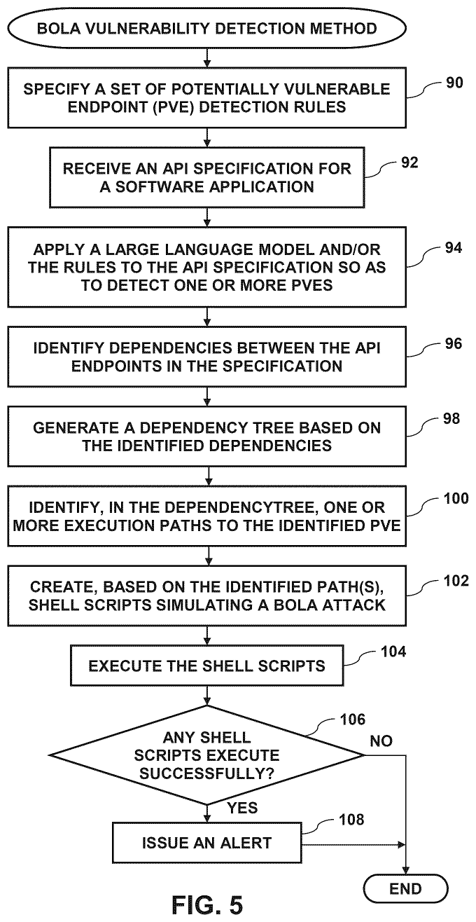

Memory 28 may additionally comprise a set of potentially vulnerable endpoint (PVE) rules 36. In some embodiments, processor 26 can analyze, using PVE rules 36, API specification 32 so as to identify any API endpoints 22 that can access, store, expose or process user information. In embodiments herein, these identified API endpoints 22 may also be referred to as PVEs 22. PVEs are typically critical to the functionality of software application 24, and therefore tend to be the most likely to be targeted by an attacker, as exploiting these endpoints typically has the most serious impacts and security implications. Some examples of PVE rules 32 are described in the description referencing FIG. 5 hereinbelow.

In some embodiments, memory 28 may further comprise a set of API endpoint records 38 that have a one-to-one correspondence with API endpoints 22. In these embodiments, for each given API endpoint 22, processor 26 can define a corresponding API endpoint record 38 that can store information such as:
An API endpoint ID 40 comprising API endpoint ID 30 for the given API endpoint.
A PVE flag 42 that processor 26 can set upon identifying (e.g., using PVE rules 36 and/or LLM 34) the given API endpoint as a given PVE endpoint 22.

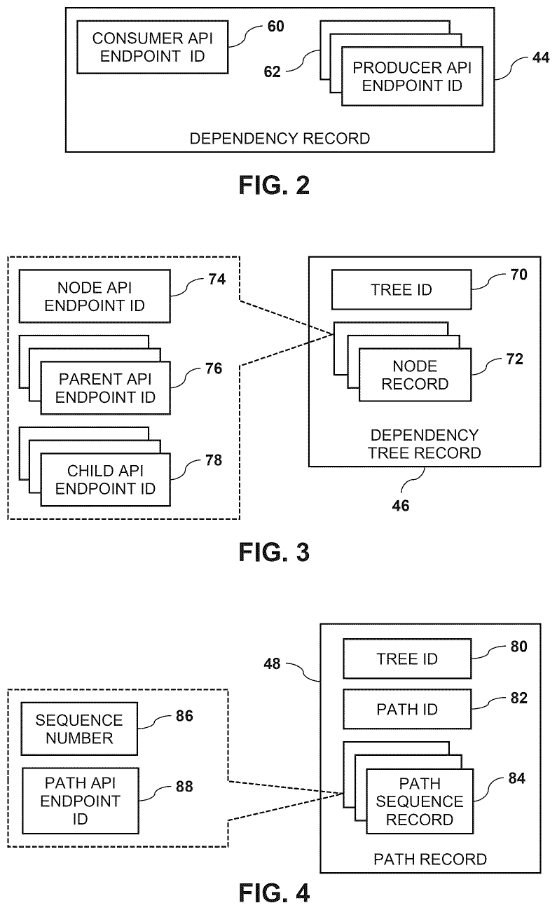

In the configuration shown in FIG. 1, memory 28 also comprises a set of dependency records 44, a set of dependency tree records 46, and a set of path records 48 that are respectively described in the descriptions referencing FIGS. 2, 3 and 4 hereinbelow. In embodiments described hereinbelow, processor 26 can use information stored in dependency records 44, dependency tree records 46, and path records 48 so as to detect any BOLA vulnerabilities in software application 24.

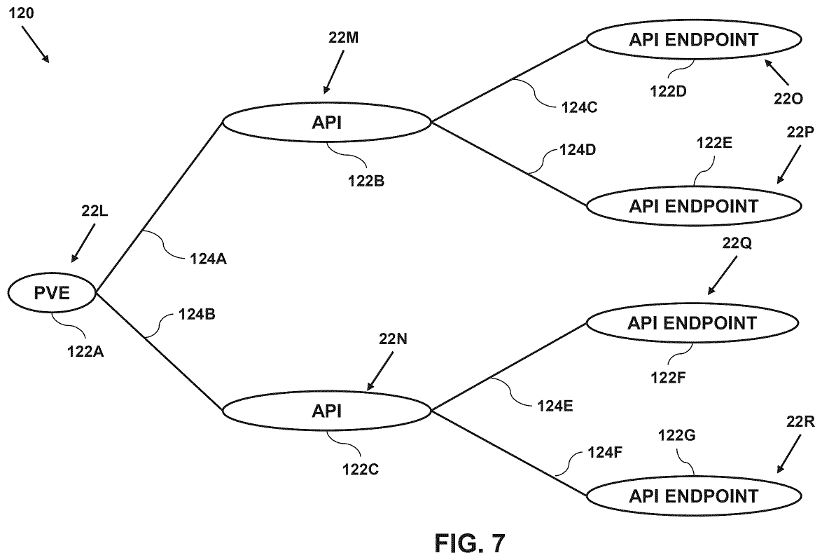

Dependency tree records 46 comprise respective tree identifiers (IDs) 70 referencing respective dependency trees. Dependency trees are described in the description referencing FIG. 7 hereinbelow.

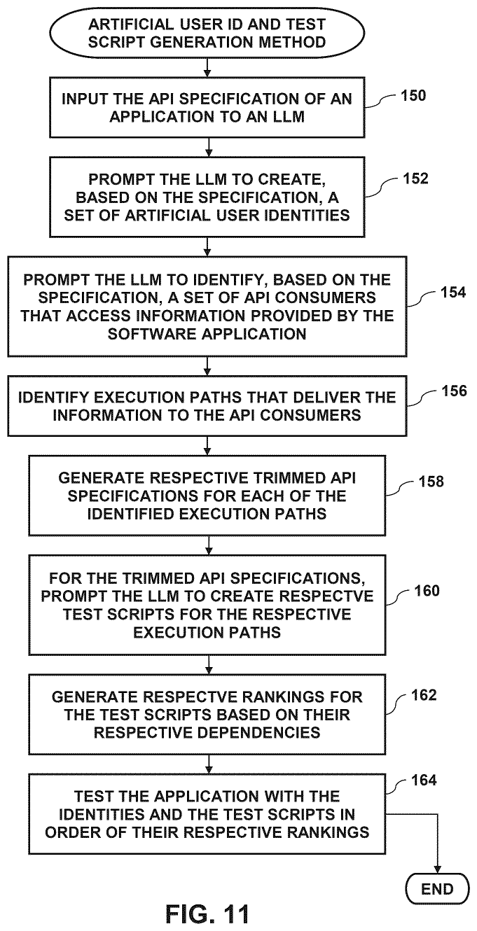

Memory 26 may additionally comprise a set of test shell scripts 50 (simply referred to herein as test scripts 50) comprising respective sets of script commands 52, respective tree IDs 53, and respective rankings 54. Each tree ID 53 comprises a given tree ID 70. As described in the description referencing FIG. 11 hereinbelow, processor 26 computes rankings 54 and uses the computed rankings to specify the order in which to execute test scripts 50.

In some embodiments, memory 26 may further comprise a plurality of access tokens 51 (also referred to herein simply as tokens 51). In these embodiments, access tokens 51 comprise digital credentials that grant specific permissions to access resources 55 or perform actions within software application 24. Access tokens 51 help maintain security by limiting access to only those resources 55 or actions that are authorized for a given user 59 and/or software application 24. The use of access tokens 51 is described in the description referencing FIG. 11 hereinbelow.

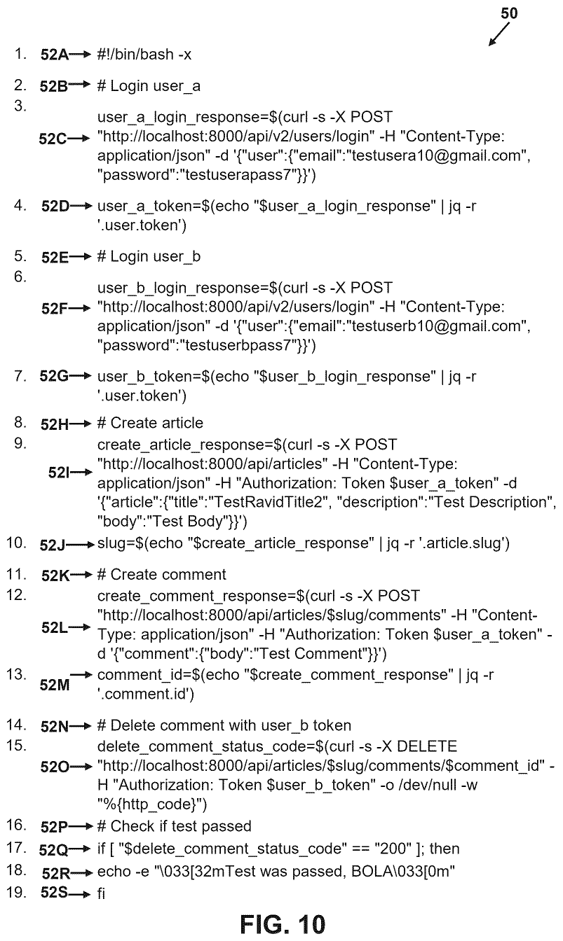

In embodiments described hereinbelow, upon processor 26 detecting a BOLA vulnerability in software application 24, processor 26 can generate one or more test scripts 50 whose respective script commands 52 attempt to exploit the detected BOLA vulnerability. In some embodiments, test scripts 50 may comprise Bourne-Again Shell (BASH) scripts. Examples of script commands 52 are described in the description referencing FIGS. 10 and 11 hereinbelow.

In some embodiments, memory 26 may further comprise a set of trimmed API specifications 56 and a set of script configuration files 58. In embodiments herein, each script configuration file comprises one or more artificial user IDs 59 referencing respective artificial (i.e., not real/actual) users. Artificial user IDs 59 may also be referred to herein simply as user IDs 59 when referencing real/actual users attempting to perform a BOLA cyberattack. Trimmed API specifications 56 and script configuration files 58 are described in the description referencing FIG. 11 hereinbelow.

FIG. 2 is a block diagram showing an example of a given decision dependency record 44, in accordance with an embodiment of the present invention. In the configuration shown in FIG. 2, each given dependency record 44 comprises a consumer API endpoint ID 60 comprising a first API endpoint ID referencing its respective API endpoint 22. Each dependency record 44 may also comprise one or more producer API endpoint IDs 62 comprising respective second API endpoint ID(s) referencing their respective API endpoint(s) 22. Note that some consumer API endpoints 22 may not need (i.e., to be paired with) any producer API endpoints 22 since they can be called directly.

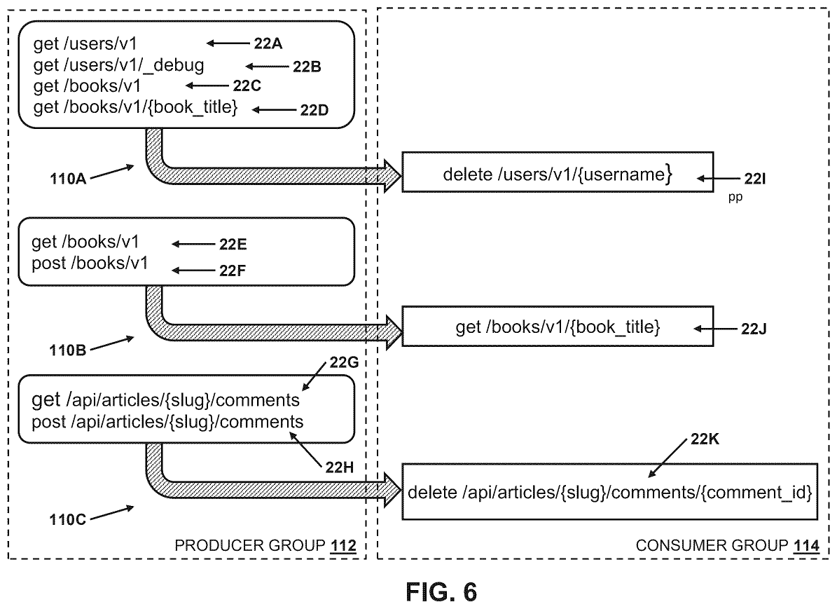

In embodiments described herein, a given second API endpoint 22 (also referred to herein as a producer API endpoint) generates (i.e., produces) output that the first given API (also referred to herein as a producer API endpoint) uses (i.e., consumes) as an input parameter. Examples of producer and consumer API endpoints are described in the description referencing FIGS. 6 and 7 hereinbelow.

FIG. 3 is a block diagram showing an example of a given dependency tree record 46, in accordance with an embodiment of the present invention. As described hereinbelow, processor 26 can generate, based on dependencies stored in dependency records 44, one or more dependency trees comprising respective sets of nodes referencing respective API endpoints 22, and can store information for each dependency tree in a corresponding dependency tree record 46. An example of a given dependency tree is described in the description referencing 7 Figure hereinbelow.

In the configuration shown in FIG. 3, each given dependency tree record 46 can store information such as tree ID 70 referencing the corresponding dependency tree, and a set of node records 72 corresponding to the nodes in the corresponding dependency tree. Each given node record 72 can store information for a given node such as:
A node API endpoint ID 74 comprising the API endpoint ID 30 for the corresponding API endpoint 22.
One or more parent API endpoint IDs 76 comprising the API endpoint ID(s) 30 for the corresponding API endpoint(s) 22 in any (direct) parent nodes of the given node.
One or more child API endpoint IDs 78 comprising the API endpoint ID(s) 30 for the corresponding API endpoint(s) 22 in any (direct) child nodes of the given node.

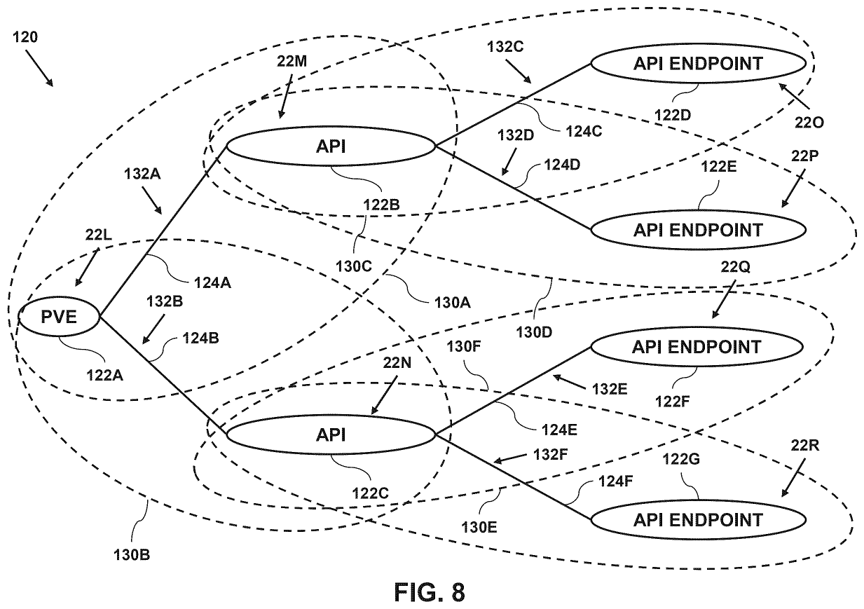

FIG. 4 is a block diagram showing an example of a given path record 48, in accordance with an embodiment of the present invention. In embodiments herein, each path record 48 describes a corresponding path that traverses a given dependency tree. Examples of paths are described in the description referencing FIG. 8 hereinbelow.

Each path record 48 can store information such as a tree ID 80, a path ID 82, and a set of path sequence records 84. For each path record 48 corresponding to a given path in a given dependency tree, tree ID 80 comprises tree ID 70 referencing the corresponding tree, and path ID 82 references the given path. An example of a dependency tree is described in the description referencing FIG. 7 hereinbelow.

The given path comprises an ordered sequence of nodes referencing corresponding API endpoints 22. Path sequence records 84 in a given path record 48 for a given path correspond to the API endpoints 22 in the given path, and each path sequence record 84 can store information such as:
A sequence number 86 indicating a position of the corresponding API endpoint in the ordered sequence. For example, if the corresponding API endpoint is the first API endpoint 22 in the ordered sequence, then its sequence number 86 is 1, if the corresponding API endpoint is the second API endpoint 22 in the ordered sequence, then its sequence number 86 is 2, and so on.
An API endpoint ID 88 comprising a given API endpoint ID 30 referencing the corresponding API endpoint 22.

Processor 26 comprises one or more general-purpose central processing units (CPU) or special-purpose embedded processors, which are programmed in software or firmware to carry out the functions described herein. This software may be downloaded to security workstation 2—in electronic form, over a network, for example. Additionally or alternatively, the software may be stored on tangible, non-transitory computer-readable media, such as optical, magnetic, or electronic memory media. Further additionally or alternatively, at least some of the functions of processor 26 may be carried out by hard-wired or programmable digital logic circuits.

Examples of memory 28 include dynamic random-access memories and non-volatile random-access memories.

In some embodiments, tasks described herein performed by processor 26 may be split among multiple physical and/or virtual computing devices. In other embodiments, these tasks may be performed in a managed cloud service.

BOLA VULNERABILITY DETECTION

FIG. 5 is a flow diagram that schematically illustrates a method of detecting a BOLA vulnerability in software application 24, in accordance with an embodiment of the present invention.

In step 90, processor 26 specifies (e.g., loads to memory 28) PVE rules 36. The following are examples of conditions for PVE rules 36 that processor 26 can use for classifying a given API endpoint 22 as a PVE (i.e., the processor can classify the given API endpoint as a PVE if one or more of the following conditions are met):
Detecting that an input parameter for the given API endpoint comprises a universally unique identifier (UUID), a globally unique identifier (GUID), a session ID, a JavaScript Object Notation (JSON) Web Token (JWT), an authentication token, or a text string having high entropy. A text string with high entropy may be an indicator of a randomly generated cryptographic key since it is close to random noise (i.e., has low repetition).
Detecting that an input parameter for the given API endpoint comprises user information that can be used to reference an existing user of the software application. Examples of these input parameters include a phone number, a Social Security Number (SSN), an email address, a passport number, a username, a user ID, an employee ID, and an account number.
Detecting that an input parameter for the given API endpoint can be used to reference a group of users of the software application. Examples of these input parameters include a group number, a group name, a role name, a team ID, a user tier, an organization ID, and a department ID.
Detecting that an input parameter for the given API endpoint can be used to uniquely identify an existing data object in the software application. Examples of these input parameters include a trip ID, a ticket ID, a post ID, a message ID, a video ID, an order number, and a secret.
Detecting that an input parameter for the given API endpoint can be used to uniquely identify an existing group of data objects in the software application. Examples of these input parameters include a video playlist, a photo album, a shopping list, and a file folder.
Detecting, for an input parameter for the given API endpoint, a schema of the parameter and its path, that the path accesses (e.g., get, post, or delete) a unique data object in the system. Examples include a GET request that returns a single photo, a POST request that updates a message, or a delete request that removes an item in a shopping cart.

In step 92, processor 26 received API specification 32 for API endpoints 22 in software application 24.

In step 94, processor 26 analyzes API specification 32 so as to detect one or more API endpoint 22s that are PVEs. The given endpoint may also be referred to herein as a PVE API endpoint 22. In a first embodiment, processor 26 can perform this analysis by applying PVE rules 36 to API specification 32. In a second embodiment, processor 26 can perform this analysis by applying LLM 34 to API specification 32. In the second embodiment, PVE rules 36 can provide high-level directions and examples for LLM 34.

In embodiments herein, PVEs are not only API endpoints 22 that expose sensitive data in software application 24, but also include the API endpoints that operate on data associated with specific users (i.e., user information). For example, processor 26 can classify a given API endpoint 22 that processes an order id parameter (i.e., an order identifier) for a given user is a given PVE, even though order id does not comprise sensitive information.

When performing step 94, processor 26 can identify parameters that are unique identifiers, such as user id, email address, order id, and team id. While these parameters may not comprise sensitive information, they can serve as indicators that there may be sensitive information in output (i.e., a response) from a given API endpoint 22.

In step 96, processor 26 applies LLM 34 to API specification 32 so as to identify dependencies between API endpoints 22 in software application 24. In embodiments herein, a given dependency comprises one or more producer API endpoints 22 for a given consumer API endpoint 22.

FIG. 6 schematically shows an example of API endpoint dependencies 110 in software application 24, in accordance with an embodiment of the present invention. In the example shown in FIG. 6, dependencies 110 and API endpoints 22 can be differentiated by appending a letter to the identifying numeral, so that the dependencies comprise dependencies 110A-110C and the API endpoints comprise API endpoints 22A-22K.

In the example shown in FIG. 6:
Dependency 110A comprises producer API endpoints 22A-22D for consumer API endpoint 22I.
Dependency 110B comprises producer API endpoints 22E-22F for consumer API endpoint 22J.
Dependency 110C comprises producer API endpoints 22G-22H for consumer API endpoint 22K.

In this example, a producer group 112 comprises API endpoints 22A-22H (i.e., the producer API endpoints), and producer group 114 comprises API endpoints 22I-22K (i.e., the consumer API endpoints).

While the example shown in FIG. 6 shows a single level of endpoint dependencies, there may be multiple levels of endpoint dependencies. For example, producer API endpoints 22A-22G in producer group 110 may also be consumer API endpoints 22 that “consume” from other producer API endpoints 22 (e.g., post/articles and get/articles).

Returning to the flow diagram, in step 98, processor 26 generates a dependency tree based on the dependencies identified in step 96.

FIG. 7 schematically shows an example of a dependency tree 120 comprising nodes 122 and edges 124 that processor 26 derived from endpoint dependencies 110, in accordance with an embodiment of the present invention.

In the example shown in FIG. 7 (and in FIG. 8, as described hereinbelow), nodes 122, edges 124 and API endpoints 22 can be differentiated by appending a letter to the identifying numeral, so that the nodes comprise nodes 122A-122G, the edges comprise edges 124A-124F, and the API endpoints comprise API endpoints 22L-22R.

In dependency tree 120, edge 124A (directly) connects nodes 122A and 122B, edge 124B connects nodes 122A and 122C, edge 124C connects nodes 122B and 122D, edge 124D connects nodes 122B and 122E, edge 124E connects nodes 122C and 122F, and edge 124F connects nodes 122C and 122G. Additionally:
Root node 122A corresponds to API endpoint 22L, and has child nodes 122B and 122C.
Node 122B corresponds to API endpoint 22M, has parent node 122A, and has child nodes 122D and 122E.
Node 122C corresponds to API endpoint 22N, has parent node 122A, and has child nodes 122F and 122G.
Leaf node 122D corresponds to API endpoint 220, and has parent node 122B.
Leaf node 122E corresponds to API endpoint 22P, and has parent node 122B.
Leaf node 122D corresponds to API endpoint 220, and has parent node 122C.
Leaf node 122D corresponds to API endpoint 22R, and has parent node 122C.

FIG. 8 schematically shows an example of producer-consumer pairs 130 in dependency tree 120 that processor 26 derived from endpoint dependencies 110, in accordance with an embodiment of the present invention. In some embodiments, processor 26 can generate dependency tree 120 based on the information stored in a given tree dependency record 46.

Depending on its task at a specific time, a given API endpoint 22 may function as an API consumer or an API producer. API consumers are applications or services that utilize APIs to access information 132 provided by API producers. In embodiments herein, information 132 comprises data, functionality, or services provided by the API producers.

API producers, on the other hand, develop and maintain APIs

to expose their data, services, or functionality (i.e., information 132) for consumption by other applications or developers. In embodiments herein, API endpoints 22 functioning as an API producers may be referred to as producer API endpoints 22, and API endpoints 22 functioning as an API consumer may be referred to as consumer API endpoints 22.

In embodiments herein, processor 26 can group API endpoints 22 into producer-consumer pairs 130 comprising a given producer API endpoint 22 and a given consumer API endpoint 22. In these embodiments, the given producer API endpoint “produces” (i.e., generates) information 132 that can be “consumed” (i.e., utilized) by the given consumer API endpoint.

In these embodiments, information 132 comprises Hypertext Transfer Protocol (HTTP) requests that are generated (i.e., produced) by the producer API endpoint in a given producer-consumer pair 130 and is received (i.e., consumed) by the consumer API endpoint in the given producer-consumer pair. In the context of web development and HTTP methods, “GET”, “PUT”, “POST”, and “DELETE” are four of the most commonly used HTTP request methods.

A GET request retrieves data from a specified resource 55, and is typically used to request data from a server. To perform a GET request, the producer API endpoint in a given producer-consumer pair 130 initiates (i.e., conveys) the GET request and the consumer API endpoint in the given producer-consumer pair receives and processes the GET request. To process the GET request the consumer API endpoint retrieves the requested resource 55 (such as a web page or a file), and sends it back to producer API endpoint as a response.

A PUT request updates or replaces a specified resource 55, and is used to send data to a server to replace so as to update the specified resource on a server. To perform a PUT request, the producer API endpoint in a given producer-consumer pair 130 initiates (i.e., conveys) the PUT request and the consumer API endpoint in the given producer-consumer pair receives and processes the PUT request. To process the PUT request the consumer API endpoint replaces or updates a specified resource 55 with the received data.

A POST request submits data to be processed to a specified resource 55, and is typically used when submitting forms or uploading files. To perform a POST request, the producer API endpoint in a given producer-consumer pair 130 initiates (i.e., conveys) the POST request and the consumer API endpoint in the given producer-consumer pair 130 receives and processes the POST request. To process the POST request the consumer API endpoint processes the data sent in the POST request body, and performs any necessary actions based on the received data.

A delete request comprises a request to delete a specified resource 55. To perform a DELET request, the producer API endpoint in a given producer-consumer pair 130 initiates (i.e., conveys) the DELETE request and the consumer API endpoint in the given producer-consumer pair 130 receives and processes the DELETE request. To process the DELETE request the consumer API endpoint interprets the request, and then performs the appropriate actions to delete the specified resource.

In the example shown in FIG. 8, producer-consumer pairs 130 and information 132 can be differentiated by appending a letter to the identifying numeral, so that the producer-consumer pairs comprise producer-consumer pairs 130A-130F, and the information comprises information 132A-132F. In this example:
Producer-consumer pair 130A comprises producer API endpoint 22M (i.e., node 122B) that produces information 132A to be consumed by consumer API endpoint 22L (i.e., node 122A).
Producer-consumer pair 130B comprises producer API endpoint 22N (i.e., node 122C) that produces information 132B to be consumed by consumer API endpoint 22L (i.e., node 122A).
Producer-consumer pair 130C comprises producer API endpoint 220 (i.e., node 122D) that produces information 132C to be consumed by consumer API endpoint 22M (i.e., node 122B).
Producer-consumer pair 130D comprises producer API endpoint 22P (i.e., node 122E) that produces information 132D to be consumed by consumer API endpoint 22M (i.e., node 122B).
Producer-consumer pair 130E comprises producer API endpoint 22Q (i.e., node 122F) that produces information 132E to be consumed by consumer API endpoint 22N (i.e., node 122C).
Producer-consumer pair 130F comprises producer API endpoint 22R (i.e., node 122G) that produces information 132F to be consumed by consumer API endpoint 22N (i.e., node 122C).

Note that a given API endpoint 22 may be a given producer in a first producer-consumer pair 130, and a given consumer in a second producer-consumer pair 130. For example, API endpoint 22M is (a) the producer in producer-consumer pair 130A, (b) the consumer in producer-consumer pair 130B, and (c) the consumer in producer-consumer pair 130C.

Returning to the flow diagram, in step 100, processor 26 identifies one or more execution paths to the given PVE API endpoint node that the processor detected in step 94. Typically, this endpoint cannot be directly accessed in software application 24. Therefore, in embodiments of the present invention processor 26 can identify an ordered sequence of API endpoints 22 that can be used to reach the given PVE endpoint. In some embodiments, this sequence can be stored to a given path record 48.

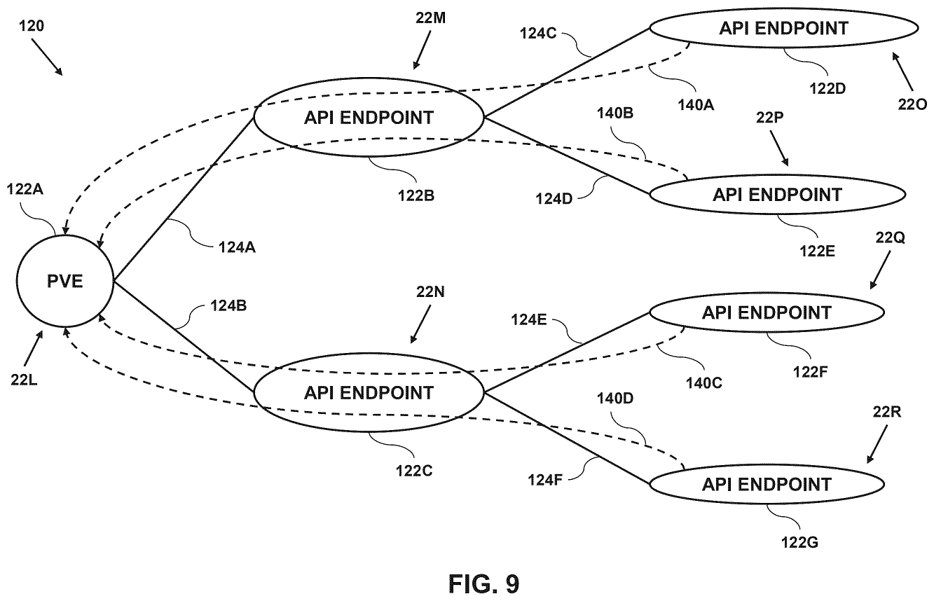

FIG. 9 schematically shows an example of execution paths 140 to PVE API endpoint 22A in dependency tree 120, in accordance with an embodiment of the present invention. In embodiments herein, paths 140 expose BOLA vulnerabilities in software application 24.

In the example shown in FIG. 9, execution paths 140 can be differentiated by appending a letter to the identifying numeral, so that the execution paths comprise execution paths 140A-140D. In this example:
The ordered sequence of execution path 140A comprises:
   a. Node 122D corresponding to API endpoint 220.
   b. Node 122B corresponding to API endpoint 22M.
   c. Node 122A corresponding to API endpoint 22L.
The ordered sequence of execution path 140B comprises:
   a. Node 122E corresponding to API endpoint 22P.
   b. Node 122B corresponding to API endpoint 22M.
   c. Node 122A corresponding to API endpoint 22L.
The ordered sequence of execution path 140C comprises:
   a. Node 122F corresponding to API endpoint 22Q.
   b. Node 122C corresponding to API endpoint 22N.
   c. Node 122A corresponding to API endpoint 22L.
The ordered sequence of execution path 140D comprises:
   a. Node 122G corresponding to API endpoint 22R.
   b. Node 122C corresponding to API endpoint 22N.
   c. Node 122A corresponding to API endpoint 22L.

The following is an example of execution path 140A.

Start with PVE endpoint 220:
delete/api/articles/{slug}/comments/{comment_id}

In this example, a first user (i.e., a first individual associated with a first artificial user ID 59) generates, for an article/slug, a comment on the article/slug. In embodiments described herein the first and the second users are “artificial” users whose respective artificial user IDs are used by test scripts 50 to test software application 24 for any security vulnerabilities such as BOLA.

A vulnerability in this endpoint allows a second user (i.e., a second individual associated with a second artificial user ID 59) to delete a comment made by the first user. Endpoint 220 can be vulnerable to BOLA because if the API server (not shown) does not correctly verify the caller, this may allow the second user (different from the first user) to delete the first user's comment. A call TO endpoint 220 requires two input parameters (a) {slug} and (b) {comment_id}. The values of these parameters need to be obtained from other API endpoints 22.

One of the API endpoints that can provide the available article/slug is
get/api/articles

With the article/slug, the next step is to obtain the list of its comments (and their comment_id). One of the API endpoints that can provide the comments of a specific article/slug is
get/api/articles/{slug}/comments

With the valid article/slug and comment_id, PVE API endpoint 220 can now be called. Mapping back to path 140A:
API endpoint 22L comprises delete/api/articles/{slug}/comments/{comment_id}
API endpoint 22M comprises get/api/articles/{slug}/comments
API endpoint 220 comprises get/api/articles

Using this example, execution path 140A comprises the following ordered sequence of API endpoints 22:
a. Node 122D referencing first API endpoint 220.
b. Node 122B referencing second API endpoint 22M.
c. Node 122A referencing third API endpoint 22L.

Returning to the flow diagram, in step 102, processor 26 uses LLM 34 to generate test scripts 50 that attempt to simulate BOLA attacks by exploiting the detected BOLA vulnerabilities.

FIG. 10 is an example of a given test script 50 comprising a BASH script that processor 26 can execute so as to attempt to exploit a detected BOLA vulnerability in software application 24, in accordance with an embodiment of the present invention. In the example shown in FIG. 9, script commands 52 can be differentiated by appending a letter to the identifying numeral, so that the script commands comprise script commands 52A-52F.

In this example: (a) a first user “UserA” creates an article, (b) UserA creates a comment for the article, and (c) A second user “UserB” deletes the comment of UserA.

These steps are performed in the given test scripts as follows:
In script commands 52C-52D, UserA logs in to software application 24 using its credentials (already registered), gets a first token in the response, and the first token is extracted and saved as “user a token”.
In script commands 52F-52G, UserB logs in to the software application 24 its credentials (already registered), gets a second token in the response, and the second token is being extracted and saved as “user_b_token”.
In script commands 521-52J, UserA creates an article in software application 24 (using “user_a_token”), and the article name (slug) is extracted and saved as “slug”.
In script commands 52L-52M, UserA creates a comment for the article “slug” (using “user_a_token”), and the comment id is extracted and saved as “comment_id”.
In script command 520, UserB initiates a BOLA attack by attempting to delete the comment “comment_id” in “slug” (using “user_b_token”). The comment belongs to UserA.

Returning to the flow diagram, in step 104, processor 26 executes the test scripts so as to simulate a series of BOLA attacks on software application 24.

In step 106, processor 26 analyzes the execution of tests scripts 50 so as to detect if software application 24 successfully executed any of the test scripts, thereby indicating a BOLA vulnerability. In some analysis embodiments, processor 26 can perform step 106 by using LLM 34 to analyze the responses from API endpoints 22 when using test scripts 50 to execute software application 24. In one analysis embodiment, LLM 34 can inspect the content of the responses in order to check whether the aligns with expected behavior (i.e., of the API endpoints). In another analysis embodiment, LLM 34 can analyze detailed information about the API endpoint requests (i.e., calls) and responses so as to verify validity of the requests and responses.

In the example described hereinabove (i.e., in step 102):
In script commands 52R-52S, processor 26 checks a status code for “delete_comment_status_code”, which is the BOLA attempt described supra.
In case the attack was successful processor 26 can classify the API endpoint (DELETE “http://localhost: 8000/api/articles/$slug/comments/$com ment id” in this case) is potentially vulnerable to BOLA.

If processor 26 detects that software application 24 successfully executed any of test scripts 50, then in step 108, the processor issues an alert (i.e., generate a notification that software application 24 is vulnerable to a BOLA attack), and the method ends.

Returning to step 106, if processor 26 detects that software application 24 did not successfully execute any of the test scripts, then no further action needs to be taken, and the method ends.

### User and Test Script Generation

FIG. 5 is a flow diagram that schematically illustrates a method of generating artificial user IDs 59 and test scripts 50, in accordance with an embodiment of the present invention. In as described hereinbelow, to test software application 24 for any security vulnerabilities such as BOLA, processor 26 can first generate multiple artificial user IDs 59, and then generate, using the artificial user IDs a set of test scripts 50.

In step 150, processor 26 inputs API specification to LLM 34.

In step 152, processor 26 prompts LLM 34 to generate, based on the input API specification, a set of artificial user IDs 59.

When testing software application 24 for any BOLA vulnerabilities, LLM 34 can generate a pair of artificial users having respective artificial user IDs 59 comprising first and second artificial user IDs 50. When attempting to detect any BOLA vulnerabilities in software application 24, test scripts 50 can be configured to log in the first and the second artificial user IDs, and a given test script 50 using the second artificial user ID can attempt to access data belonging to the first artificial user ID.

In a first user creation step, LLM 34 can generate information that processor 26 can store to a given script configuration file 58. In some embodiments, the given script configuration file can store information necessary to register a pair of artificial users for software application 24. In this example the artificial users are “user a” and “user_b”, and the registration information for each the artificial users comprises a username (i.e., the artificial user ID), a password and an email address.

The following is an example for the given script configuration file 58 (in this case called AUTH. YAML):

```
description: Reusable test stage for authentication - Vampi
name: Authentication stage
variables:
  users:
    user_a:
      username: ‘abc1’
      password: ‘abc1231’
      email: abc1@abc.com
    user_b:
      username: ‘xyz1’
      password: ‘xyz1231’
      email: xyz1@xyz.co′
```

In a second user creation step, LLM 34 can generate a first test script 50 that that a second test script 50 can use to register the pair of artificial users. The following is an example of the first test script:

```
test name: Register 2 users
includes:
    include auth.yam1
stages:
    name: Register User 1
    request:
      url: http://localhost: 5000/users/vi/register
      method: POST
      headers:
        Content-Type: application/json
      json:
        username: “(users.user.a.username: s)”
        email: “users.user_a.email:s}”
        password: “fusers.user.a.password:)”
    response:
      status_code: 200
name: Register User 2
  request:
    url: http://localhost: 5000/users/v3/register
    method: POST
    headers:
      Content-Type: application/json
    json:
      username: “{users.user_b.username: s}”
      email: “fusers.user_b.email: s}”
      password: “users.user_b.password: s}”
  response:
    status code: 200
```

In this example, the first test script 50 provides (e.g., to the second test script) (a) information stored in AUTH. YAML to register User 1 (i.e., user_a in AUTH. YAML) and User 2 (i.e., user_b in AUTH. YAML), and (b) the uniform resource locator (URL) “http://localhost: 5000/users/v3/register” for registering the users for software application 24.

In a third user creation step, LLM 34 can generate script commands 52 that the LLM can use to generate any test scripts 50 that can perform, for software application 24, login operations for the registered artificial users. The following is an example of the script commands:

```
servers:
    url: http://localhost:5000
token:
    auth_token
Login path:
  /users/v1/login
Login JSON format:
  {“username”: “USER_NAME”, “password”: “USER_PASSWORD”}
```

In this example, the script commands (a) provide a URL for a server hosting software application 24, (b) provide a path for the login operation, (c) provides a mapping for the artificial user login information stored in AUTH. YAML, and (d) specifies a given token 51 (i.e., auth token) for a given artificial user ID 59.

When generating test scripts 50 for checking BOLA vulnerabilities, the manipulation of tokens 51 is very important as they are typically used by software application 24 as identifiers for users referenced by respective ratification user IDs 59. For example, a first user UserA will have a first unique token 51 while a second user UserB will have a second unique token 51 (i.e., different from the first unique token).

In some embodiments, LLM 34 can insert the script commands in the example shown hereinabove into a given test script 50. When executing on processor 26, these script commands generate tokens 51 upon logging in respective artificial user IDs 59 into software application 24, and the software application can subsequently use these tokens when calling API 23. In other words, the generated tokens enable calling API 23 when testing the software application.

A BOLA cyberattack can exploit tokens 51 as shown in the following steps:
1. A first user UserA logs in (using a first user ID 59) to software application 24, receives a first token 51, and processor 26 saves the first token as user a token.
2. In response to UserA interacting with software application 24, the software application generates a new resource 55, and saves the generated resource as {resource_id}. Therefore, {resource_id} “belongs” to UserA.
3. A second user UserB logs in (using a second user ID 59) to software application 24, receives a second token 51, and processor 26 saves the second token as user b_token.
4. UserA performs an action on the resource referenced by {resource_id}, and processor 26 saves an action identifier for the performed action as {action_id}.
5. UserB attempts to execute, on processor 26, program instructions (e.g., in script commands 52) that perform an unauthorized action on {action_id} of {resource_id}. As described supra, {resource_id} belongs to UserA.
   a. In one example, the unauthorized action comprises UserB attempts to manipulate the resource referenced by {resource_id}.
   b. In another example, UserA performs an additional (i.e., authorized) action on the resource referenced by {resource_id}, and UserB then attempts to delete the resource. In this example, the resource may comprise an article, the first authorized action comprises UserA generating the article, the second authorized action may comprise UserA generating a comment for the article, and the unauthorized action comprises UserB attempting to delete the comment,

Note that the information used for logging an artificial user into software application 24 may be a proper subset (also known as a strict subset) of the information needed to register the artificial user to the software application. In the example described hereinabove, information required to register a given artificial user comprises a given artificial user ID 59, a password and an email address, but the information required to log into the software application comprises a given artificial user ID 59 and a password (i.e., email address is not required).

Returning to the flow diagram, in step 154, using embodiments described hereinabove, processor 26 prompts LLM 34 to identify, based on the input API specification, a set of consumer API endpoints 22 (also referred to herein simply as API consumers 22) that access information 132 provided by software application 24. In some embodiments, the identified consumer API endpoints comprise PVEs 22, as described hereinabove.

In step 156, using embodiments described hereinabove, LLM 34 can identify, based on the input API specification, one or more execution paths 140 that convey information 132 to the identified API consumers. These identified paths comprise one or more producer API endpoints 22.

In one embodiment, processor 26 can use LLM 34 to generate, based on the input API specification, respective script configuration files 56 for the consumer API endpoints identified in step 154. These script configuration files are referred to hereinbelow as consumer script configuration file 56.

In these embodiments, a given consumer script configuration file 56 can store information on the corresponding consumer API endpoint 22 and the one or more producer API endpoints 22 that are in any of the execution paths leading to the corresponding consumer API endpoint. In addition to generating respective consumer script configuration files 56 for execution paths 140 (as shown in the example hereinbelow), LLM 34 may also generate, based on API specification 32, an additional consumer script configuration file 56 (e.g., a JSON file) that comprises all the information (i.e., from the API specification) info for all PVEs 22 and all the execution paths in software application 24.

The following is an example of a given consumer script configuration file 56 that is configured as a JAVASCRIPT Object Notation (JSON) file:

```
{
  “/users/v1/{ username)/password”: {
    “put”:{
      “success status code”: 284,
      “exec paths”: [
        “get/users/v1”
      ]
    }
  }
}
```

The JSON file listed above can be for a given producer API endpoint 22 that performs a PUT operation, and the producer API endpoint (i.e., for the given producer API endpoint 22) is referenced by “get/users/v1” that performs a GET operation.

In another embodiment, processor 26 can use LLM 34 to generate, based on the input API specification, respective script configuration files 56 for the producer API endpoints identified in step 156. These script configuration files are referred to hereinbelow as producer script configuration file 56.

In these embodiments, a given producer script configuration file 56 can store information on the corresponding producer API that LLM 34 can extract from API specification 32.

The following is an example of a given producer script configuration file 56 that is configured as a JAVASCRIPT Object Notation (JSON) file and stores information for the producer API endpoint referenced by “get/users/v1” (as described hereinabove):

```
{
  “/users/v1/{username}/password”: {
    “put”:{
      “con required parms”: {
        “path”: [
          “username”
        ]
        “application/json”: [
          “password”
        ]
      },
      “successful_status_code”: [
        204
      ]
      “prod_paths”: [
        {
          “prod_path”: “/users/v1”,
          “prod_method”: “get”,
          “prod_required_parms”: { } ,
          “prod_parm_location”: “response”,
          “prod_parameter”: “username”,
          “con_parm_location”: “path”,
          “con_parameter”: “username”
        }
      ]
    }
  }
}
```

Examples of information (i.e., characteristics) stored in script configuration JSON the producer file described hereinabove includes, but is not limited to:
A location of the consumer required parameter (con_required_param). In this example, the username parameter located in the path (which can be located also in the body of the request) and the password parameter can be located in the JSON (which is the body of the request).
A successful status code.
Information about the producers (prod_paths). This information can include the path, the HTTP method, any parameters this producer requires (in this case none), a name of a required parameter in the producer request, and a name of the same parameter in the consumer request.
Information about the location of the parameters. In the producer request shown hereinabove, the parameter username can be located as part of the response. However, when this parameter is used by a given consumer API endpoint, it can be located in the path.

In the producer script configuration file described hereinabove, the name of the parameter in the consumer request example is the same, i.e., username. However, there could be instances where there are discrepancies between parameter names (i.e., referencing the same information) in different API endpoints. For example, in a given producer API endpoint 22, a given parameter may be called username and in a given consumer API endpoint, the same parameter may be called name, and using this info is how we match them even in cases of discrepancies. In this example, LLM 34 can match producer parameter username to the consumer parameter name upon making a connection (i.e., a pairing) between the given consumer API endpoint and the given producer API endpoint. LLM 34 can store this pairing information in producer script configuration files 56.

In step 158, using the producer and the consumer script configuration files generated in steps 154 and 156, LLM 34 generates respective trimmed API specifications 56 for the execution path identified in step 156. In some embodiments, the trimmed API specification for a given path 140 comprises information that LLM 34 extracts from API specification 24 (only) for the consumer API endpoint and for the one of more producer API endpoints 22 in the given path.

In embodiments described herein, LLM 34 analyzes API specification to generate respective test scripts 50 for execution paths 140. As described supra, software application 24 may comprise a large number of API endpoints 24, so using LLM 34 to analyze all the API endpoints to generate the test script for a given execution path can be unwieldly and cumbersome (especially if generating test scripts 50 for software applications having in excess of 100,000 execution paths as described supra).

The following is an example of a subset of information in a given trimmed API specification 56 that LLM 34 extracted from API specification 24.

```
paths:
  /users/v1/username/password:
    put:
      description: Update users password
      operationId: api views.users.update_password
      parameters:
        -description: username to update password
        in: path
        name: username
        required: true
        schema:
          example: namel
          type: string
        requestBody:
          content:
              responses: ‘204’:
                application/json: schema:
                  properties:
                    password:
                      example: pass4 type: string
                      type: object
          description: field to update
          required: true
        responses:
          204:
            content: { }
            description: Sucessfully updated users password
            ‘400’:
              content:
                application/json:
                  schema:
                    properties:
                      message:
                        example: Malformed Data
                        type: string
```

In step 160, for each trimmed API specification 56, processor 26 prompts LLM 34 to generate respective test scripts 50. In some embodiments, LLM can include the generated artificial user identities in the generated test scripts (e.g., for testing for any BOLA vulnerabilities)

In step 162, processor 26 identifies dependencies between the test scripts, and based on the identified dependencies, ranks generated test scripts so as not to break any dependencies. In other words, processor 26 can rank the scripts to ensure that the scripts have access to resources 55 referenced by their respective requests. In some embodiments, processor 26 can rank the test scripts by generating respective rankings 54 (i.e., for the test scripts)/

Executing test scripts in order of their respective rankings can prevent situations such as (a) executing a first test script 50 comprising a GET request for a given resource 55 prior to executing a second test script 50 comprising a PUT or POST request for the given resource, and (b) executing a first test script 50 comprising a GET request for a given resource 55 subsequent to executing a second test script 50 comprising a DELETE request for the given resource.

As described supra, each path 40 comprises a single consumer API endpoint 22 (i.e., a given PVE 22) and one or more producer API endpoints. In some embodiments, processor 26 can generate rankings 54 based on the requests (i.e., HTTP methods) in the paths corresponding to the rankings. In these embodiments, processor 26 can generate rankings 54 so that the processor can execute test scripts 50 in the following order that uses the request in the consumer API endpoint (i.e., the HTTP request in the endpoint) of each path 140 as a primary key:
First execute test scripts 40 whose respective consumer API endpoints comprise GET requests.
Next execute test scripts 40 whose respective consumer API endpoints comprise POST requests.
Next execute test scripts 40 whose respective consumer API endpoints comprise PUT requests.
Next execute test scripts 40 whose respective consumer API endpoints comprise DELETE requests.

In these embodiments, processor 26 can generate rankings 54 using the request in the producer API endpoint (i.e., the HTTP request in the endpoint) of each path 140 as a secondary key (i.e., secondary to the primary key described supra):
First execute test scripts 40 whose respective producer API endpoints comprise POST requests.
Next execute test scripts 40 whose respective producer API endpoints comprise GET requests.
Next execute test scripts 40 whose respective producer API endpoints comprise PUT requests.
Next execute test scripts 40 whose respective producer API endpoints comprise DELETE requests.

As described supra, each path 140 comprises one or more producer API endpoints 22. If a given path 140 comprises more than one producer API endpoint 22, processor 26 can select the secondary key (described supra) based on the following logic:
DELETE>PUT>POST>GET

In other words, a given producer API endpoint 22 comprising a DELETE request is “stronger” than a given producer API endpoint 22 comprising a PUT request which is stronger than a given producer API endpoint 22 comprising a POST request which is stronger than a given producer API endpoint 22 comprising a GET. Therefore, if a given path 140 comprises both PUT and GET producer API requests 22, then processor 26 selects the PUT request as the secondary key for generating the ranking.

Finally, in step 164, processor 26 tests software application 24 with the generated test scripts (comprising artificial user IDs 59) so as to discover any security vulnerabilities (e.g., BOLA) in the software application, and the method ends. In some embodiment, test scripts 50 may comprise one or more script configuration files 52 (e.g., for registering users 59), or may comprise information stored in the script configuration files.

To test software application 24 with the generated test scripts, processor 26 can execute the test scripts in order of their respective rankings. In some embodiments, the test scripts attempt to exploit security vulnerabilities such as BOLA, and successful execution (i.e., completion) of a given test script 50 can indicate such a security vulnerability.

During testing, processor 26 executes test scripts 50 “against” API endpoints 22, receive responses from the API endpoints, and analyzes the responses so as to determine whether any PVEs 22 in software application 24 are vulnerable to BOLA. Test scripts! 50 that LLM 34 generates using embodiments described hereinabove perform operations such as user registration, user login, and token refresh so as to ensure uninterrupted execution of the test scripts.

By executing test scripts 50 in a specific order (e.g., based on their respective 54), detecting any “failures” in the executed test scripts typically indicates that the PVEs in software application 24 are not vulnerable to BOLA (i.e., rather than the failures being in response to any technical issues in the software application). Executing test scripts 50 in the specific order populates the application with resources 54 (e.g., data) before fetching them, thereby ensuring that the resources exist before they are being fetched. Additionally, executing test scripts 50 in the specific order “pushes” back (i.e., to the end of the test) test scripts 50 comprising actions like updating or deleting users (i.e., user IDs 59) or resources 55, thereby preventing attempts to fetch deleted or modified resources 55.

On the other hand, successful completion of test scripts 50 indicates a BOLA vulnerability in one or more PVEs in software application 24. Upon detecting successful completion of test scripts 50, logs and outputs of each test script 50 can analyzed so as to pinpoint any vulnerabilities. This analysis can be performed by an artificial intelligence (AI) algorithm (i.e., by inputting the logs and outputs to LLM 34) and/or by an analyst (i.e., typically a human).

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for testing a software application, comprising:
inputting, to a large language model (LLM), a specification of an application programming interface (API) of the software application;
prompting the LLM to create, based on the specification, a set of artificial user identities; and
testing the software application with the created user identities to discover a security vulnerability in the software application.

2. The method according to claim 1, wherein the API comprises multiple API endpoints, and wherein the specification of the API comprises a specification of the API endpoints.

3. The method according to claim 1, wherein the security vulnerability comprises a broken object level authorization vulnerability.

4. The method according to claim 1, wherein the specification comprises an OpenAPI specification.

5. The method according to claim 1, and further comprising promoting the LLM to identify, based on the specification, a first set of information required to register each given artificial user identity with the software application, and generating, using the first sets of information, a registration test script to register the artificial user identities with the software application, and wherein testing the software application comprises executing the registration test script.

6. The method according to claim 5, and further comprising promoting the LLM to identify, based on the specification, a second set of information required to log each given artificial user identity into the software application, and generating, using the second sets of information, a login test script to log the artificial user identities into the software application, wherein the second set comprises a subset of the first set, and wherein testing the software application comprises executing the registration test script.

7. The method according to claim 6, wherein the subset comprises a proper subset.

8. A computer software product for identifying a vulnerability in a software application, the computer software product comprising a non-transitory computer-readable medium, in which program instructions are stored, which instructions, when read by a computer, cause the computer:
to input, to a large language model (LLM), a specification of an application programming interface (API) of the software application;
to prompt the LLM to create, based on the specification, a set of artificial user identities; and
to test the software application with the created user identities to discover a security vulnerability in the software application.

9. A method for testing a software application, comprising:
inputting, to a large language model (LLM), a specification of an application programming interface (API) of the software application;
prompting the LLM to identify, based on the specification, a set of API consumers that access information provided by the software application;
for each given API consumer in the set, prompting the LLM to identify, based on the specification, one or more execution paths leading to the given consumer from respective API producers, which deliver the information to the software application;
prompting the LLM to generate, based on the specification, respective test scripts to test the identified execution paths; and
testing the software application with the generated test scripts to discover a security vulnerability in the software application.

10. The method according to claim 9, wherein the API comprises multiple API endpoints, and wherein the specification of the API comprises a specification of the API endpoints.

11. The method according to claim 10, wherein the API endpoints comprise producer and consumer API endpoints, wherein the producer API endpoints produce output, and wherein each of the consumer API endpoints consumes the output of a given producer API endpoint as an input parameter.

12. The method according to claim 11, wherein each of the paths comprises a given consumer API endpoints and one or more producer API endpoints.

13. The method according to claim 12, wherein the API specification comprises information for each of the API endpoints, and further comprising generating for each given path, a trimmed API specification comprising the information for the producer API endpoint and the one or more producer API endpoints in the given path, and wherein prompting the LLM to generate the test script for the given path comprises prompting the LLM to generate, based on the trimmed API specification, the test script for the given path.

14. The method according to claim 12, and comprising identifying dependencies between the test scripts, ranking the test scripts based on their respective dependencies, and executing the test scripts in order of their respective rankings.

15. The method according to claim 14, wherein ranking the test scripts comprises identifying, for each of the consumer API endpoints, a primary key comprising a consumer operation selected from a list consisting of a GET operation, a POST operation, a PUT operation and a DELETE operation, and ranking the test scripts based on a primary key, wherein, in the primary keys, the ranking for a given script whose respective consumer operation comprises a GET operation is greater than a given script whose respective consumer operation comprises a POST operation, wherein the ranking for a given script whose respective consumer operation comprises a POST operation is greater than a given script whose respective consumer operation comprises a PUT operation, and wherein the ranking for a given script whose respective consumer operation comprises a PUT operation is greater than a given script whose respective consumer operation comprises a DELETE operation.

16. The method according to claim 15, and further comprising identifying a set of scripts having identical primary keys, identifying, for each of the producer API endpoints in the set, a secondary key comprising a producer operation selected from a list consisting of a POST operation, a GET operation, a PUT operation and a DELETE operation, and ranking the test scripts in the set based on the secondary key, wherein, in the secondary key, the ranking for a given script whose respective producer operation comprises a POST operation is greater than a given script whose respective producer operation comprises a GET operation, wherein the ranking for a given script whose respective producer operation comprises a GET operation is greater than a given script whose respective producer operation comprises a PUT operation, and wherein the ranking for a given script whose respective producer operation comprises a PUT operation is greater than a given script whose respective producer operation comprises a DELETE operation.

17. The method according to claim 16, wherein upon detecting one of the scripts comprising multiple producer endpoints, assigning a delete operation to the secondary key of detected script if any of the multiple producer endpoints in the detected script comprises any DELETE operations, assigning a PUT operation to the secondary key of detected script if any of the multiple producer endpoints in the detected script comprises any PUT operations and does not comprise any DELETE operations, assigning a POST operation to the secondary key of detected script if any of the multiple producer endpoints in the detected script comprises any POST operations and does not comprise any DELETE operations or any PUT operations, and assigning a GET operation to the secondary key of detected script if any of the multiple producer endpoints in the detected script comprises any GET operations and does not comprise any DELETE operations any PUT operations or any POST operations.

18. The method according to claim 9, wherein the security vulnerability comprises a broken object level authorization vulnerability.

19. The method according to claim 9, wherein the specification comprises an OpenAPI specification.

20. An apparatus for testing a software application, comprising:
a memory configured to store a large language model (LLM); and
a processor configured:
to input to the LLM, a specification of an application programming interface (API) of the software application,
to prompt the LLM to identify, based on the specification, a set of API consumers that access information provided by the software application, for each given API consumer in the set, to prompt the LLM to identify, based on the specification, one or more execution paths leading to the given consumer from respective API producers, which deliver the information to the software application,
to prompt the LLM to generate, based on the specification, respective test scripts to test the identified execution paths, and
to test the software application with the generated test scripts to discover a security vulnerability in the software application.

21. A computer software product for identifying a vulnerability in a software application, the computer software product comprising a non-transitory computer-readable medium, in which program instructions are stored, which instructions, when read by a computer, cause the computer:
to input, to a large language model (LLM), a specification of an application programming interface (API) of the software application;
to prompt the LLM to identify, based on the specification, a set of API consumers that access information provided by the software application;
for each given API consumer in the set, to prompt the LLM to identify, based on the specification, one or more execution paths leading to the given consumer from respective API producers, which deliver the information to the software application;
to prompt the LLM to generate, based on the specification, respective test scripts to test the identified execution paths; and
to test the software application with the generated test scripts to discover a security vulnerability in the software application.
